(19) United States
(12) Patent Application Publication
(10) Pub. No.: US 2026/0291926 A1
(43) Pub. Date: Sep. 24, 2026

(54) TIERED IDENTITY VERIFICATION FRAMEWORK

(71) Applicant: Zendesk, Inc., San Francisco, CA (US)

(72) Inventors: Andrew Lavers, Pointe-Claire (CA); James Peter Strain, Melbourne (AU); Timothy McClean, Melbourne (AU); James Hanley, Melbourne (AU); Luke Maximillian McCal, Piedmont, CA (US); Ryan Scott, Melbourne (AU)

(73) Assignee: Zendesk, Inc., San Francisco, CA (US)

(21) Appl. No.: 19/085,956

(22) Filed: Mar. 20, 2025

(51) Int. Cl. H04L 9/40; H04L 67/306

(52) U.S. Cl. CPC H04L 63/08; H04L 67/306

(57) ABSTRACT

Systems and methods are provided for implementing a tiered user identity verification framework. Instead of traditional standardized Boolean verification (i.e., yes or no), the framework includes multiple tiers (more than two), each having at least one corresponding identity verification method, with higher levels requiring more robust verification. A ‘low’ tier may simply require an agent to manually indicate that a user identity has been verified, while a ‘full’ tier may require execution of an email verification flow (assuming the user identity is an email address). Primary user identities must be unique, but multiple different users may share a secondary pseudo-identity called a contact. Until an identity or contact has been verified according to an approved method, it may be flagged as pending. Some organizations may partition users into directories, wherein uniqueness is required within each directory, but users in different directories may have the same identity.

### BACKGROUND

This disclosure relates to the field of computer systems. More particularly, a system and methods are provided for performing verification of online users.

Online organizations that interact with users may or may not require uniqueness in their users' online identities. Allowing online purchases, providing customer assistance, and/or performing other activities without enforcing uniqueness may make a given organization's system easy for users, but can cause difficulty when the organization desires to communicate with a specific user.

Moreover, one user may possess multiple login credentials that are associated with a single email address (or other identity), such as when he or she uses it to establish distinct user accounts with multiple online businesses. Although the email address is unique to this person, it may be insufficient to identify the context of a current interaction or to identify all relevant previous interactions between the user and an organization that supports the multiple businesses (e.g., by providing customer support, shipping, or payment mechanisms). The organization's interaction with the user may depend upon which set of credentials he or she is currently using or the business with which the user is currently dealing.

Another organization may enforce uniqueness so that when it receives a communication from a particular authenticated email address or containing some other authenticated identity, it can be sure who it is communicating with and how to contact that person. However, this organization may also wish to allow users (e.g., new users) to communicate with the organization without authenticating. For example, if the organization is a vendor, it may wish to allow new users to populate a shopping cart and obtain some level of customer support regarding his or her desired purchases without having to authenticate. This provides a user-friendly experience, but then the organization will need to maintain information regarding authenticated and unauthenticated users and, moreover, determine how to handle communications that appear to be from an authenticated user, based on a specified identity, but that may be from a malicious actor attempting to impersonate that authenticated user.

Further, although some security schemes attempt to enforce uniqueness among users' email addresses (or other identities), they often employ a simple Boolean value to indicate whether a particular email address has or has not been verified. A problem with this is that, through social engineering and/or deficient attention to detail on the part of an organization's agent (e.g., a customer service representative), an email address may have been manually marked as verified even though it was not reliably verified.

### SUMMARY

In some embodiments, systems and methods are provided for implementing a multi-tier identity verification framework. In these embodiments, an end user is known to an organization (e.g., a customer support center, an online business) with a primary identity (e.g., email address) that must be unique among the organization's users. The organization sets a minimum identity verification tier that specifies a method (or a set of alternative methods) that must be satisfied before a new end user's identity is considered verified. Thus, the organization can require agents to perform an auditable form of identity verification (e.g., via single sign-on, via a digitally signed token) instead of simply manually marking a user identity as verified (which is vulnerable to social engineering). Different tiers may be selected or applied for different purposes (e.g., describing a product, changing or canceling an order).

To accommodate new users and/or existing users who interact with the organization without logging in, the organization may also implement pseudo-identities, which may be termed ‘contacts,’ and which may be shared among users. In other words, multiple end users may share a pseudo-identity (which may be an email address), which may also be verified, such as when multiple users share a common work email address. Until an identity or pseudo-identity is verified (e.g., via an email verification flow, via a single sign-on flow), it may be placed in a ‘pending’ state.

To accommodate end users whose relationships with an organization differ from time to time, such as a user of a ride-share app who may sometimes be a driver and sometimes a rider, or a user that deals with multiple subsidiaries of a business organization, users of the organization may be segregated into directories. User identities must be unique within each directory of the organization, but different users in different directories (e.g., one user in different roles, one user that shops at multiple subsidiaries) may have the same identity across directories. Applicable identity verification tiers and/or policies for applying a tiered identity verification framework may differ between directories, just as they may differ between organizations and in different contexts.

### DESCRIPTION OF THE FIGURES

FIG. 1 is a block diagram depicting an exemplary computing environment in which an organization may implement a multi-tiered user identity authentication framework, in accordance with some embodiments.

FIG. 2 is a block diagram illustrating the organization of user data within the environment of FIG. 1, in accordance with some embodiments.

FIG. 3 is a table of illustrative identity verification tier that may be applied to assist enforcement of uniqueness among end users' identities, in accordance with some embodiments.

FIG. 4 is a flow chart illustrating a method of implementing a tiered user identity verification framework, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system and methods are provided for securing user data by enforcing uniqueness of users' online identities while permitting selective use of non-unique identifiers. For example, non-unique identifiers may be allowed temporarily before they are verified. To support this flexible arrangement, an organization that hosts user data implements an identity verification framework in which users' identities are not verified in simply a Boolean manner (i.e., verified or not verified) but, instead, can be verified according to any of multiple (greater than two) different tiers. Each tier is associated with one or more methods for verifying a user identity, and methods associated with different tiers may provide different levels of trustworthiness. Further flexibility is provided by requiring authentication according to different tiers in different contexts. Although email addresses are primary online identities in most cases, related or similar embodiments may be implemented with different types of identities (e.g., telephone numbers, usernames, nicknames, etc.).

In these embodiments, when a uniqueness constraint is active for a pool of users, one email address (or other specified identity) cannot be employed for two different users. In some implementations, however, users may also be assigned pseudo-identifiers, termed ‘contacts’ herein, which can be shared among multiple users with no uniqueness constraint. Also, or instead, a ‘pending’ tag or flag may be assigned to an identity or contact so that, for example, new users with unverified identities can be accommodated without causing frustrating user experiences. A pending identity or contact may become an identity if it is verified in accordance with the applicable minimum requirement.

A central concept associated with embodiments described herein is the separation between users and identities of those users. Specifically, a given user may change his or her email address, telephone number, and/or other identity, or add another identity (e.g., a new personal or work email address, a telephone number). Thus, for many or even most users, there will be a one-to-many relationship between the user and his or her identities and, when uniqueness is enforced, their primary identities must be unique.

Embodiments of a multi-tier identity verification framework may be implemented by organizations that interact with large numbers of users. Uniqueness of identities allows these organizations to know they are communicating with the users with whom they intend or expect to communicate, to associate interactions (e.g., customer support chats) with the correct users, to detect attempted fraudulent use of a user's identity, to avoid sharing one user's data with another user, etc.

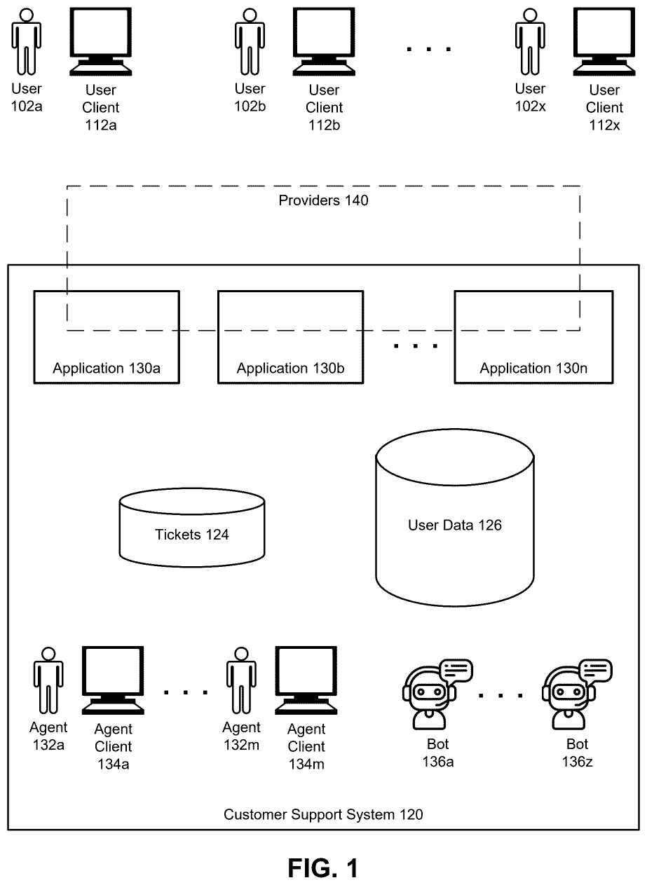

FIG. 1 is a diagram of an illustrative environment in which an organization may implement a tiered framework for verifying user identities, according to some embodiments.

In the environment of FIG. 1, an organization provides applications and operates a customer support system to support use of the applications. Specifically, customer support system 120 hosts applications 130 (e.g., applications 130a-130n) and provides assistance for those applications via human agents 132a-132m, which operate agent clients 134a-134m, and bot agents 136a-136z. In some implementations, customer support system 120 and applications 130 may be provided by different entities. Thus, although applications 130 are depicted as residing within customer support system 120 in FIG. 1, in some embodiments the applications may be distinct from the customer support system.

Each application 130 is used (e.g., subscribed to) by any number of providers 140 (e.g., businesses, governmental entities, and/or other organizations) to support interaction with end users 102a-102x, which access the applications via user clients 112a-112x. For example, providers 140 may include online vendors (e.g., retailers, wholesalers) and/or service providers that use applications 130 to support sales or provision of their goods/services to end users 102. Providers 140 may offer limited assistance to users 102 and may rely upon customer support system 120 for robust customer support. Thus, end user clients 112 are coupled to providers 140, which in turn are coupled to customer support system 120.

End user clients 112 access the physical and/or virtual computers that host applications 130 via any number and type of communication links. For example, some user clients 112 may execute installed software for accessing any or all applications; this software may be supplied by providers 140 and/or customer support system 120. Other user clients 112 may execute browser software that communicates with web servers that are associated with (e.g., that host) applications 130. The web servers may be operated by customer support system 120, the organization that hosts customer support system 120, and/or providers 140.

In some implementations, a user client 112 may access customer support system 120 and applications 130 directly (e.g., via one or more networks such as the Internet); in other implementations, a user client 112 may first connect to a provider 140 (e.g., a website associated with a particular provider) and be redirected to customer support system 120. In yet other implementations, one or more applications 130 may execute upon computer systems operated by a provider 140, in which case application data are reported to or retrieved by customer support system 120.

In some embodiments, end users 102 use applications 130 in the context of specific providers. In other words, in these embodiments each user session with an application is associated with at least one provider 140. The context may be set when an end user is redirected to customer support system 120 from the corresponding provider's site, when the end user logs in using credentials provided by the provider, or in some other way.

When an end user 102 has a problem or question about a product or service offered by a provider 140, to obtain assistance the end user can access customer support system 120, possibly via a provider 140. For example, a user 102 of a provider 140 that sells retail goods may need help canceling an order that was erroneously entered. This help may be provided by a live customer service agent 132 and/or a bot agent 136. In addition to or instead of assisting end users and/or providers with applications 130, a customer support agent 132, 136 may offer information and/or services, such as product support, operating instructions, a package-delivery service, returning an item, canceling or modifying an order, changing a travel itinerary, etc.

Customer support system 120 manages user/provider issues using tickets 124 and other resources as necessary. In the illustrated embodiments, a ticket represents an electronic conversation between entities depicted in FIG. 1, such as an end user 102 and customer support system 120; a provider 140 and customer support system 120; or an end user 102 and a provider 140. End users 102 and providers 140 may submit tickets through a variety of channels, including electronic mail, web form, chat, call, text, social media, and API (Application Programming Interface) calls through third-party providers or customer integrations. Each ticket 124 includes various data and metadata associated with the issue and actions taken to resolve it. Ticket database or repository 124 may take any form and may be centralized or distributed.

Each ticket is generally associated with one user (or provider, depending on the associated issue), which the organization naturally desires to identify with specificity. As described above, the organization may therefore enforce uniqueness among the identities (e.g., email addresses) that it uses to identify the users. Trustworthy enforcement of uniqueness requires the identities proffered by new and returning users to be appropriately verified, as described below.

Customer support system 120 maintains user data records within user data 126, which may be a database or other type of repository and which may be centralized or distributed. User data 126 includes records identifying users by unique primary identities and/or by pseudo-identities (e.g., contacts), any of which may be pending or shared. Customer support system 120 and/or providers 140 may implement security policies that specify which tier to apply at any given time based on the context, which may comprise factors such as the current user's identity, which provider the user's current session is associated with, the purpose of the current session, and so on.

Exemplarily, user data records in user data 126 may point to or otherwise reference tickets in tickets store 124. This allows an agent 132, 136 to quickly access a user's open and/or closed tickets. Also, and as described below, directories (not shown in FIG. 1) allow segregation of a providers' users in some circumstances, without sacrificing the requirement for uniqueness among identities within the segregated user domains.

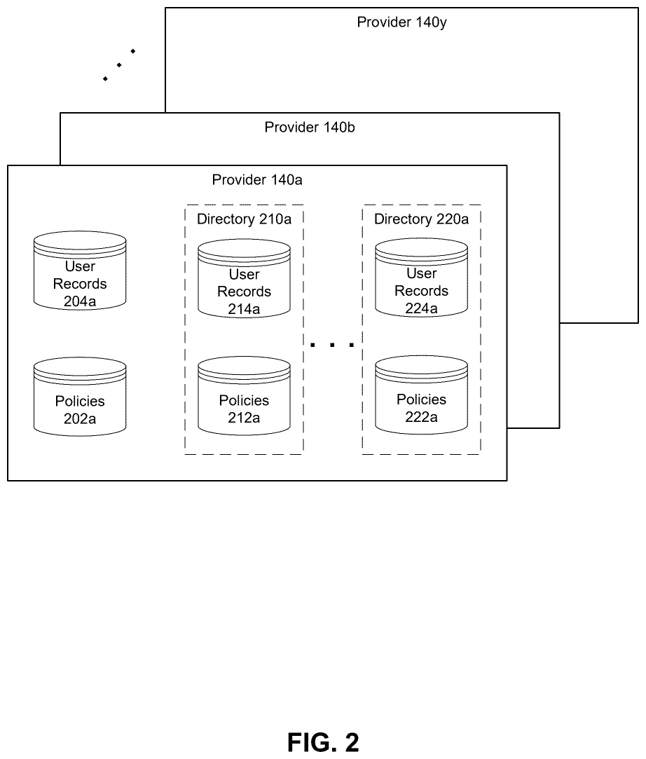

FIG. 2 illustrates the composition of user data within the environment of FIG. 1, according to some embodiments. In these embodiments, each provider 140 has a separate account with the organization that hosts customer support system 120, and each provider's data for its end users are distinct from other providers' user data, even when one user interacts with multiple providers 140. Thus, as shown in FIG. 2, each of providers 140a-140y has a corresponding collection of user data unique to that provider.

Some providers' user data will primarily comprise policies 202 (e.g., policies 202a for provider 140a) and user records 204 (e.g., user records 204a for provider 140a). Policies 202 comprise the provider's applicable tiered security framework, identify which identity verification methods are approved for each tier, specify when to apply one (or more) of a selected tier's methods (e.g., based on context), and/or other information regarding how and when to apply the provider's selected identity verification framework. User records 204 include user identity records (e.g., records regarding end users' verified identities), user contact records (e.g., records regarding users' unverified identities), and/or other information.

Optional directories 210-220 (e.g., directories 210a to 220a for provider 140a) reflect a feature that may be implemented by a provider that exposes multiple brands or businesses to end users, a provider that operates in multiple markets (e.g., in different geographic areas), a provider that is a conglomerate or that operates multiple subsidiaries that each interact with end users, and/or other types of providers that may interact with a given end user through multiple entities or with different types of relationships. For example, a first end user may interact with (e.g., shop online at) both Banana Republic and Gap, using the same email address or other identity, with or without knowing that both companies are owned by The Gap, Inc. As another example, a second user may interact with a ride-share application in different roles—sometimes as a driver and at other times as a rider. In these examples, one user interacts with one provider in multiple different contexts.

Such a provider may naturally wish to maintain separate records of its user interactions for its different brands, businesses, markets, or user roles, in which case the provider's user records are segregated accordingly. Each directory includes its own collection of policies (e.g., policies 212a-222a) and user records (user records 214a-224a). In this scenario, a user named Alice could have separate user records based on a single identity (e.g., alice@email.com) in each directory, thereby maintaining uniqueness within each directory. Depending on how Alice connects to system 120 (e.g., which of provider 140a's subsidiaries she connects to, which role she connects in, which identity provider delivers a login flow), one of directories 210a-220a applies and the corresponding policies will be enforced during her session. Similarly, details of her interaction will be stored in the applicable user records repository (e.g., one of user records 214a-224a).

Thus, in FIG. 2, a provider typically either (a) implements separate directories, each having associated policies 212-222 and user records 214-224, or (b) foregoes the use of directories and instead implements central stores of policies 202 and user records 204. In some implementations, however, a provider may do both, such as when a new end user appears and it is unclear which directory the new user belongs to, or the new user does not fit the criteria for application of any existing directory.

In some embodiments, agents 132, 136 of customer support system 120 may be limited to accessing only one directory of a given provider's user data, to avoid seeing all of one user's interactions across all directories, although a manager or supervisor may be able to view all such data. By segregating records in this manner, an agent whose access is limited to one (or more) of a provider's directories can update or modify a user's data without information leaking to other agents limited to accessing other directories and/or applications.

In some implementations, when a provider employs directories, user records in the provider's different directories that pertain to the same end user may be assigned linking identifiers that a manager may use to access the user's data across directories. The user may or may not use or have the same email address in each directory, so the separate cross-directory linking identifier facilitates aggregation of the user's data.

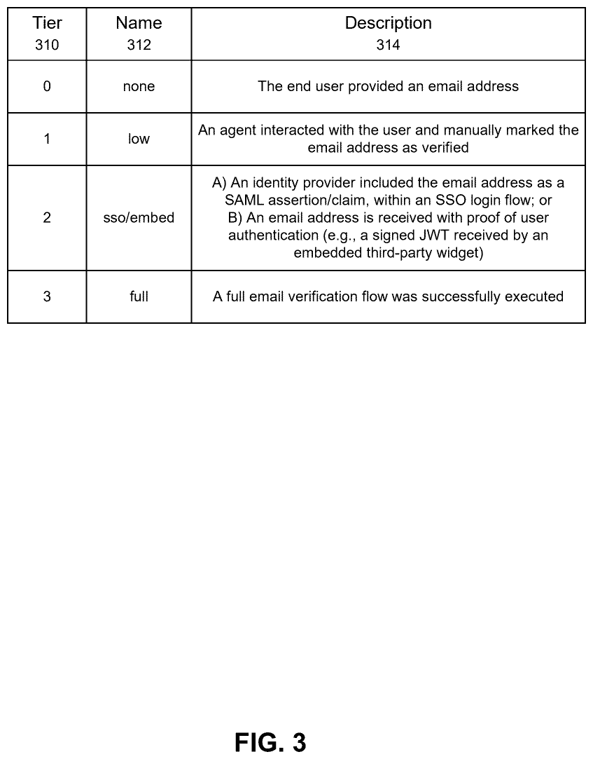

FIG. 3 is a table listing exemplary identity verification tiers, according to some embodiments. In these embodiments, identities of end users that interact with an organization (e.g., the organization that hosts customer support system 120 of FIG. 1) are verified according to one of four tiers, which may be selected by the organization (or a provider 140) based on its desired security policies. Each tier 210, from 0 to 3, has a corresponding name 212 and description 214 and includes or specifies one or more acceptable identity verification methods.

At tier 0, verification is ‘none,’ and is appropriately assigned when an end user provides an email address (or other identity) and no verification is performed, such as when a user engages in a first communication with an agent 132, 136 in the environment of FIG. 1 by submitting a question (e.g., via chat or text message).

At tier 1, verification is ‘low’ and, in the illustrated embodiments, means an agent manually indicated that the user's email address was verified, during or in association with an interaction with the user. For example, a human agent may communicate with the user via email, telephone, text messages, or chat. During the communication, the end user may provide a password, answer a security question, provide personal data, or offer other information that leads the agent to mark the user's identity as verified.

This tier of the verification framework may be satisfied whether or not the address was truly verified. In other words, an organization agent 132, 136 may mark the identity as verified without any actual technical or auditable verification, meaning there is no electronic record of reliable verification. Notably, in embodiments described herein, no agent, operator, or supervisor can upgrade a tier 1 (or tier 0) verification status to tier 2 or tier 3. And as one skilled in the art will appreciate, tier 1 is the highest level of user identity authentication that can be implemented without executing a systemic verification flow.

At tier 2, which may be called an ‘sso’ or ‘embed’ tier of verification, a security protocol or method is conducted or asserted by a provider 140 or other entity external to the organization that operates customer support system 120. Thus, a source of the user's identity may have included it within a SAML (Security Assertion Markup Language) assertion or claim within an SSO (Single Sign-On) login flow.

As one example, a user may connect to customer support system 120 of FIG. 1 via a given provider 140 after signing in using an account created for him or her by that provider or by an identity provider associated with the provider. The provider may then deliver a SAML-based SSO to system 120 to log her in for customer support and/or other purposes. As another example, a user may log into a mobile app associated with a provider 140 and start a chat with customer support via an agent 132, 136 through an application 130 provided for that purpose. The provider signs a JWT (JSON (JavaScript Object Notation) Web Token) and delivers it to customer support system 120 via the embedded widget or SDK (Software Development Kit), with an email address claim or other verifiable identity claim for the user. In these examples, the organization operating customer support system 120 has little or no control over the user's login or sign-in process, nor the user's identity, and therefore may not find the identity verification method to be completely trustworthy. By way of illustration, the provider's identity provider may allow a user to change his or her email address identity without executing a verification process to ensure the user has control of that address, or may have other flaws.

At tier 3, the organization (e.g., an agent 132, 136) successfully executes a full email address verification flow. This primarily involves verifying that an email sent to the address is received by the user (e.g., by sending a verification code for the user to report).

In some implementations, a user's interaction with different providers, different applications, and/or for different purposes may require verification at different tiers of the framework. For example, a user identified by a given email address may connect to a customer support agent 132, 136, and ask questions about a flight itinerary, which may require a relatively low level of identity verification to answer. If, however, the user then requests the agent to change his or her itinerary, and if the user's identity has not already been verified at a higher tier (e.g., ‘full’) specified by an applicable policy, the agent may require satisfaction of an email verification flow before complying with the request.

As mentioned above, in some embodiments, a user's identity may be marked as pending. To illustrate a reason for this feature, assume the organization that operates customer support system 120 of FIG. 1 has interacted with a user named Alice and verified her email address identity alice@email.com at tier 3 of the framework of FIG. 3 after completing a proper verification flow. This means there is an identity record in user data 126 that includes Alice's name and her email address, with a tag or other indicia indicating that the address has been fully verified. Now say she connects to customer support system 120 (e.g., an agent 132, 136) from a new or different device (e.g., an iPad) with a random or pseudo-random name (e.g., iPad user 14526). This manner of connection prevents the organization from immediately knowing that this is Alice. Illustratively, she may be using the device to identify an order she placed with a provider 140, to return something or request some other assistance.

Maybe this user entered the alice@email.com email address in a help request form or a chat session, but anyone could connect to system 120 and make the same assertion. Therefore, an agent of system 120 cannot assume that ‘iPad user 14526’ is Alice, and does not associate that email address as an identity for iPad user 14526 or otherwise assume that iPad user 14526 is Alice.

Instead, customer support system 120 may create a new ‘contact’ for ‘iPad user 14526’ and set an associated ‘pending’ flag. As a result, besides the user identity record for the real Alice, user data 126 now contains a contact record for this iPad user that is also associated with Alice's verified email but that is marked ‘pending.’ As described above, multiple users (having different identities) may share one contact (or pseudo-identifier).

The identity verification tier (e.g., low, sso, embed, full) required for this user for the current context (which may be set by customer support system 120 or a provider 140 associated with the order associated with this customer support interaction) will determine what needs to be done to accept this proffered identity as valid. Illustratively, in the environment of FIG. 1, and as reflected in FIG. 2, each provider 140 has a separate account with customer support system 120 (or the organization that hosts system 120). A provider's account may specify the minimum identity verification tier to be applied to users that connect to the provider or system 120, and may include other settings as well, such as whether shared contacts are permitted or whether an identity or contact may be placed in a pending state. In this illustration, each user identity record in user data 126 that corresponds to a user will have been (or will be) verified to the specified tier.

‘iPad user 14526’ could, of course, log in with Alice's login data (if she is Alice) and thereby verify the link between Alice and ‘iPad user 14526,’ or an agent 132, 136 could ask this user to prove she is Alice by, for example, answering a security question previously configured by Alice. If one of these things happens, the user contact record for iPad user 14526 can be recognized as verified and therefore merged with Alice's record if Alice's record (alice@email.com) had been verified using a method corresponding to a higher tier than what was now applied. Conversely, if the new verification method is associated with a tier higher than what was used previously for Alice and her alice@email.com identity, then that email address may move from the ‘Alice’ identity record to the contact record created for ‘iPad user 14526.’ The customer support session then continues with the agent knowing that he/she is dealing with Alice.

An associated feature helps prevent user data 126 from becoming cluttered with invalid user records (e.g., stale or malicious contact records). For example, Alice may be a celebrity, an influencer, or some other person of interest, and imposters may attempt to impersonate her or try to obtain information about Alice from customer support system 120. As seen above, anyone can connect to the system and enter Alice's email address on a help request form. Those actions will cause new contact records to be created with the imposters' apparent ids (e.g., iPad user xxxxx, Mobile user yyyyy) and with Alice's email address, but in a pending state. There could be a plethora of imposter records without any of them being successful in persuading an agent to verify them.

By implementing a ‘cleanup pending contacts’ feature and setting it to True (e.g., in the provider's account with customer support system 120), when Alice completes an acceptable method of identity verification (e.g., by logging in with a full identity verification flow), the system will know that this is the real Alice, and can remove all imposter records that had ‘pending’ statuses associated with her email address. This cleanup simplifies support agents' views of user data and helps mitigate the risk of impersonation attacks.

Thus, providers 140 in the environment of FIG. 1 may opt to implement any of the verification methods depicted in FIG. 3 and described above. The more trustworthy the verification method, the less chance of a malicious user successfully impersonating another user. A provider may change approved methods over time to either increase or decrease the strength of the verification. Exemplarily, when a provider increases the required verification tier, subsequent logins from new and existing users will be required to satisfy a new, more trustworthy, verification method associated with the selected tier. Thus, if a less trustworthy verification method of the framework was removed or disallowed, the user may now be required to complete a more trustworthy method (e.g., an email verification flow).

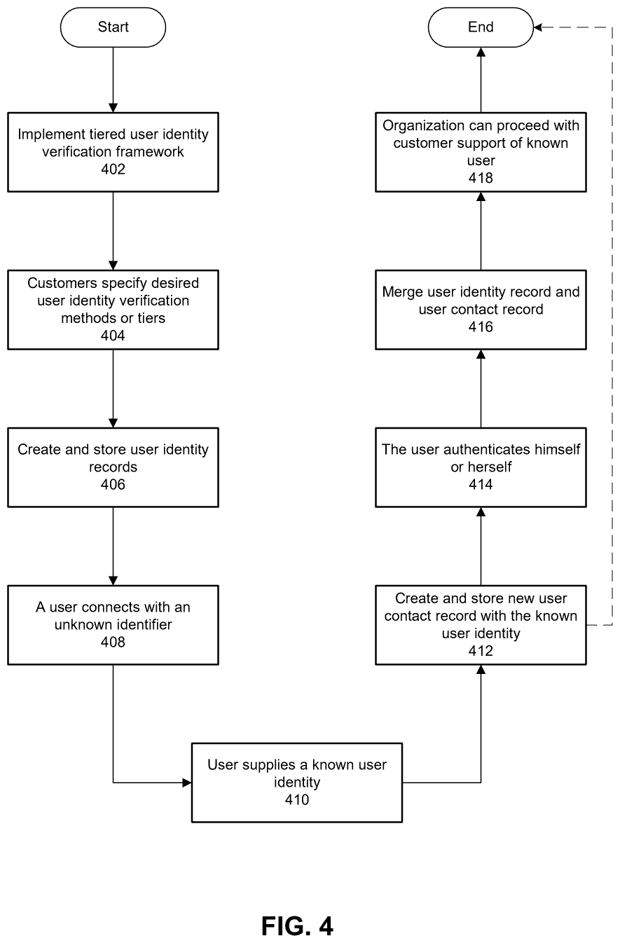

FIG. 4 is a flowchart of a method for implementing a tiered user identity verification framework, according to some embodiments. One or more of the illustrated steps may be omitted, repeated, and/or performed in a different order. Accordingly, the specific arrangement of steps shown in FIG. 4 should not be construed in a manner that limits the scope of the embodiments.

In operation 402, an organization that provides or hosts customer support services for multiple online businesses and/or other entities (collectively termed “customers” in the description of this method), each of which has online users, implements a tiered user identity verification framework, such as the framework depicted in FIG. 3.

In operation 404, customers of the organization select tiers of the framework for implementation with their users. Thus, different customers may select different tiers and, as a consequence, customer support agents of the organization will enforce the associated or specified methods when they receive requests for assistance from the customers' users.

In operation 406, for each customer, over time, the organization assembles user identity records that associate unique user identities (e.g., email addresses) with specific users. For example, as new users sign-on to customers' systems, satisfy an approved method of user identity verification, and adopt or are assigned unique user identities, those identities are saved in user data 126 of customer support system 120 of FIG. 1 (e.g., in user identity records) and/or elsewhere. A given user may have one or more verified user identities, but each unique user identity is associated with only a single user. Each user identity is unique among each customer's user population except, perhaps, for customers that implement user directories as already discussed, but a given user identity may appear in multiple different customers' user populations (e.g., for users who shop at multiple customers' online sites).

Each user may also have an associated identifier that may match his or her verified user identity or that may comprise other information. For example, a given user may verify his or her email address for use as an identity, but may also (or instead) be known by his or her name (e.g., “Alice,” “Bob”), a screen name, an account name or number, or some other identifier.

Uniqueness benefits the customers and the organization by making users distinctly identifiable, allowing each user's actions (e.g., purchases, customer support tickets) to be tracked accurately, avoiding fraud involving one user masquerading as another, enhancing security by being able to specifically identify malicious actors, etc. Also, being able to tie all user activities and data to specific users improves the integrity and consistency of all stored user data. Further, user privacy is more easily enforced when user identities must be unique.

Existing users of a customer may usually connect to the customer or the organization (e.g., to shop, to obtain customer support) via a single device that can supply a cookie, token, or other information that allows the customer or organization to know or at least suspect it is receiving a connection from a known user.

However, in operation 408, a user connects to the organization (e.g., by seeking customer support) using a device that identifies the user with an identifier unknown to the organization (e.g., not reflected in any stored user identity record). For example, a browser or mobile application may identify the user with a generic name (e.g., Mobile User 279). This may be a new user not previously encountered by the organization or it may be an existing user who is using a new or different device than he or she normally uses (in which case it cannot provide a cookie or other token).

In operation 410, the user supplies a user identity via chat, in an online form, or in some other manner, wherein the user identity has a matching user identity record stored with the organization, meaning that the user identity has been verified according to a tier of the tiered user identity verification framework.

In operation 412, even though the asserted identity is known, because the user has not authenticated himself or herself, and because the current identifier provided by the user's device is unknown to the system, the system cannot assume that this user is the owner of the verified user identity. Therefore, the system creates a new contact record and stores it. Because it is not an identity record, it can contain the user identity that is already associated with a known user without violating the uniqueness constraint.

Note that the system will not share any data associated with the known user with the current, unauthenticated user, at least not unless and until he or she authenticates as the known user. Until the current user performs such authentication, the system may refrain from sharing order information, accessing the known user's payment methods, etc. Thus, the illustrated method may end after 412 if the current user (who may be an imposter) cannot or will not prove his or her identity.

In operation 414, the current user authenticates himself or herself as the known user. The user may simply login, for example, or may answer a security question previously configured by the known user. Notably, however, the authentication must satisfy the applicable identity verification method to proceed, or the method may end by denying the user's request.

In operation 416, the user identity record and the new contact record are merged because they are associated with the same user, unless they are in different directories. This may also cause user data and previous interactions to be merged (e.g., a shopping cart of the current user and a prior transaction history of the known user). Other activity of the user may also be aggregated. For example, if the user possesses other user identities (e.g., a telephone number, other email addresses), they may be merged into the same user identity record, especially if the current identity verification was completed at a higher tier of the framework than the other user identities.

In operation 418, the organization (e.g., a customer support agent) can proceed to assist the user with confidence that it is the known user. After operation 418 the method ends.

Methods and systems described above for implementing a multi-tier identity verification framework enhance the security of user data, especially within businesses or other organizations that have large numbers of users. For example, by applying a uniqueness constraint, an organization ensures that each primary user identity is associated with a single user and, by enforcing the identity verification framework, also ensure that it does not share one user's data with another user. Meanwhile, by allowing for pseudo-identities, the organization can accommodate new users and existing users that make online connections with new or different devices or mechanisms.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method, comprising:
selecting a minimum tier of a multi-tier user identity verification framework for verifying identities of users of an online computing system, wherein each tier of the framework, including said minimum tier, corresponds to a set of verification methods;
saving a first user identity record for a first user having a first user identity that verified the first user identity according to the selected minimum tier;
receiving a communication from a second user that asserts the first user identity without authenticating as the first user;
saving a first user contact record for the second user, wherein the first user contact record is placed in a pending state; and
merging the first user identity record and the first user contact record only when the second user satisfies one of the verification methods corresponding to the minimum tier or a higher tier of the framework.

2. The method of claim 1, wherein the multiple tiers comprise:
a first tier in which a corresponding verification method involves a given user providing a user identity without verifying the user identity;
a second tier in which a corresponding verification method involves an agent marking the user identity as valid without performing an auditable verification process;
a third tier in which a corresponding verification method involves receiving a claim to the user identity asserted by an external entity; and
a fourth tier in which a corresponding verification method involves execution of a user identity verification flow.

3. The method of claim 1, further comprising:
enforcing uniqueness across users' identities such that only one user identity record may include a given user identity and the only one user identity record is associated with only one user.

4. The method of claim 1, wherein:
the method is implemented by an organization having online users;
the organization partitions the online users into multiple directories; and
the organization enforces uniqueness across users' identities such that, within each directory, only one user identity record may include a given user identity and the only one user identity record is associated with only one user.

5. The method of claim 1, wherein said merging comprises:
merging user data associated with the second user with user data associated with the first user; and
deleting the first user contact record.

6. The method of claim 5, wherein said user data comprises one or more of:
a shopping cart comprising one or more items; and
a communication history between the second user and a customer support system.

7. The method of claim 1, wherein said merging comprises:
identifying, to the first user, user data associated with the second user; and
querying the first user whether to retain or discard the user data.

8. The method of claim 1, wherein the multi-tier user identity verification framework is implemented by an organization that provides customer support services to users of multiple online businesses that are distinct from the organization.

9. The method of claim 8, wherein the multi-tier user identity verification framework comprises:
a first tier in which an agent marks the user identity as valid without verifying the user identity in an auditable manner;
a second tier in which a claim to the user identity is received by the organization from one of the multiple online businesses; and
a third tier in which the organization executes a user identity verification flow.

10. A system for verifying user identities, the system comprising:
one or more processors; and
memory storing instructions that, when executed by the one or more processors, cause the system to:
select a minimum tier of a multi-tier user identity verification framework for verifying identities of users of an online computing system, wherein each tier of the framework, including said minimum tier, corresponds to a set of verification methods;
save a first user identity record for a first user having a first user identity that verified the first user identity according to the selected minimum tier;
receive a communication from a second user that asserts the first user identity without authenticating as the first user;
save a first user contact record for the second user, wherein the first user contact record is placed in a pending state; and
merge the first user identity record and the first user contact record only when the second user satisfies one of the verification methods corresponding to the minimum tier or a higher tier of the framework.

11. The system of claim 10, wherein the multiple tiers comprise:
a first tier in which a corresponding verification method involves a given user providing a user identity without verifying the user identity;
a second tier in which a corresponding verification method involves an agent marking the user identity as valid without performing an auditable verification process;
a third tier in which a corresponding verification method involves receiving a claim to the user identity asserted by an external entity; and
a fourth tier in which a corresponding verification method involves execution of a user identity verification flow.

12. The system of claim 10, wherein the memory further comprises instructions that, when executed by the one or more processors, cause the system to:
enforce uniqueness across users' identities such that only one user identity record may include a given user identity and the only one user identity record is associated with only one user.

13. The system of claim 10, wherein:
the system is operated by an organization having online users;
the organization partitions the online users into multiple directories; and
the organization enforces uniqueness across users' identities such that, within each directory, only one user identity record may include a given user identity and the only one user identity record is associated with only one user.

14. The system of claim 10, wherein said merging comprises:
merging user data associated with the second user with user data associated with the first user; and
deleting the first user contact record.

15. The system of claim 14, wherein said user data comprises one or more of:
a shopping cart comprising one or more items; and
a communication history between the second user and a customer support system.

16. The system of claim 10, wherein said merging comprises:
identifying, to the first user, user data associated with the second user; and
querying the first user whether to retain or discard the user data.

17. The system of claim 10, wherein the multi-tier user identity verification framework is implemented by an organization that provides customer support services to users of multiple online businesses that are distinct from the organization.

18. The system of claim 17, wherein the multi-tier user identity verification framework comprises:
a first tier in which an agent marks the user identity as valid without verifying the user identity in an auditable manner;
a second tier in which a claim to the user identity is received by the organization from one of the multiple online businesses; and
a third tier in which the organization executes a user identity verification flow.

19. A non-transitory computer-readable medium storing instructions that, when executed by a processor, cause the processor to perform a method comprising:
selecting a minimum tier of a multi-tier user identity verification framework for verifying identities of users of an online computing system, wherein each tier of the framework, including said minimum tier, corresponds to a set of verification methods;
saving a first user identity record for a first user having a first user identity that verified the first user identity according to the selected minimum tier;
receiving a communication from a second user that asserts the first user identity without authenticating as the first user;
saving a first user contact record for the second user, wherein the first user contact record is placed in a pending state; and
merging the first user identity record and the first user contact record only when the second user satisfies one of the verification methods corresponding to the minimum tier or a higher tier of the framework.
